(19) United States
(12) Patent Application Publication
(10) Pub. No.: US 2025/0018681 A1
(43) Pub. Date: Jan. 16, 2025

(54) Thermal Management Composite Material

(71) Applicant: eXclaim IP, LLC, Cornelius, NC (US)

(72) Inventor: Kevin Conway, Cornelius, NC (US)

(21) Appl. No.: 18/829,010

(22) Filed: Sep. 9, 2024

Related U.S. Application Data
(63) Continuation of application No. 18/233,630, filed on Aug. 14, 2023.
Application No. 18/233,630 is a continuation of application No. 17/346,235, filed on Jun. 12, 2021, now Pat. No. 11,724,478.
Application No. 17/346,235 is a continuation of application No. 17/226,684, filed on Apr. 9, 2021, now Pat. No. 11,858,246.
Application No. 17/226,684 is a continuation of application No. 16/844,990, filed on Apr. 9, 2020, now Pat. No. 11,254,091.
Application No. 16/844,990 is a continuation-in-part of application No. 15/820,289, filed on Nov. 21, 2017, now Pat. No. 10,669,090.
(60) Provisional application No. 63/537,086, filed on Sep. 7, 2023.
(60) Provisional application No. 62/424,579, filed on Nov. 21, 2016.
(60) Provisional application No. 62/460,946, filed on Feb. 20, 2017.
(60) Provisional application No. 62/460,943, filed on Feb. 20, 2017.
(60) Provisional application No. 62/492,382, filed on May 1, 2017.
(60) Provisional application No. 62/492,386, filed on May 1, 2017.

(51) Int. Cl. B32B 5/24; A45C 11/00; A61J 1/16; B32B 1/00; B32B 5/02; B32B 5/18; B32B 27/06; B32B 27/34; B32B 27/36; G06K 19/077

(52) U.S. Cl. CPC B32B 5/245; A45C 11/00; A61J 1/16; B32B 1/00; B32B 5/02; B32B 5/18; B32B 27/065; B32B 27/34; B32B 27/36; G06K 19/07758; A45C 2011/002; A45C 2011/003; B32B 2255/10; B32B 2262/0276; B32B 2307/71; B32B 2307/73

(57) ABSTRACT

A thermal management composite material including three primary layers, and in aspects functional apertures across an outermost layer of the material. The first layer is a first metalized material attached to a first woven or non-woven material. The second layer is an ultra-low thermally conductive material layer. The third layer is a second metalized material attached to a second woven or non-woven material. The composite is capable of being shaped or formatted into a variety of available shapes. The composite provides for improved thermal management.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent files or records, but otherwise reserves all copyright rights whatsoever.

### RELATED APPLICATIONS

See Application Data Sheet for list of cross-references, which are hereby incorporated herein by reference.

### FIELD OF INVENTION

The present invention relates generally a composite material and more specifically to a composite material having a plurality of layers providing for thermal management.

### BACKGROUND

Airplanes are heavily sealed and pressurized, thus when you're on the ground and the doors are closed you're basically the equivalent of the car sitting there in the parking lot with all the windows closed. The maximum temperature considered comfortable for passengers, preboarding, is generally as high as 90 degrees fahrenheit.

Certain airlines have procedures for crew members and agents to close window shades and open-air vents on the cabin any time the temperature climbs above 80 degrees. In an effort to maintain a comfortable temperature within the aircraft while an aircraft is parked at the gate, a PCA system is utilized. Preconditioned Air Units, or simply PCA units, are giant air conditioners that provide a comfortable environment inside an aircraft when the aircraft's own air conditioning system is not switched on. PCA units supply fresh conditioned air having comfortable temperature and humidity to the aircraft cabin when the aircraft is parked on the aircraft stand (or ramp).

Such a PCA system comprises ambient air that is treated (filtered, compressed, cooled, or heated) in a compressor system (basically an oversized air conditioner). The air is then fed directly into the interior of the aircraft cabin via an insulated hose. However, unlike domestic air conditioners that recirculate a lot of air, PCA units generally don't recirculate any air. They supply only fresh air to the aircraft after dropping its temperature, if it is summer season or, raising its temperature, if it is winter season.

In most cases the PCA system (unit and the insulated hose) are directly exposed to the outside environment. The extreme heat of the summer or the cold of the winter can cause major life cycle issues for a PCA system (unit and the insulated hose), such as, by way of example, negatively affecting an ability to transport the cold airconditioned air to the aircraft during the extreme heat of the summer or heated airconditioned air during the extreme cold of the winter.

There is a need for improved thermal management of the PCA unit and the insulated hose, especially given the weather extremes brought about by global warming.

### BRIEF DESCRIPTION

The present invention provides varying embodiments of thermal management composite material overcome prior art problems noted above.

A first, second, and third embodiment includes thermal management composite material including three primary layers. These layers can include: a) a metalized material attached to a woven or non-woven material; b) an ultra-low thermally conductive material layer; and c) a metalized material attached to a woven or non-woven material. In aspects, the outer layer includes apertures or openings with zones between the apertures (also described herein as perforations) providing functionality to the outer layer and overall composite material.

A fourth embodiment includes a thermal management cover, wherein the cover is comprised of four layers: a) an outer woven or non-woven material layer, either of which comprises a plurality of perforations; b) a metalized material layer; c) an ultra-low thermally conductive material layer; and d) an inner woven or non-woven material.

A fifth embodiment includes a thermal management cover. The cover is comprised of one or more panels, wherein a panel is comprised of three primary layers: a) a fiber reinforced plastic board comprised of one or more of: carbon, fiberglass, and/or polyethylene terephthalate glycol, known as PETG or PET-G; b) one or more of polystyrene or another low conductive material; and c) fiber reinforced plastic board comprised of one or more of: carbon, fiberglass, and/or PETG.

### BRIEF DESCRIPTION OF THE DRAWINGS

FIG. 1 illustrates one embodiment of the first, second, and third embodiment of the thermal composite material;

FIGS. 2-5 illustrate varying embodiments of shapes of the thermal composite material of FIG. 1;

FIG. 6 illustrates one embodiment of the thermal management cover with spacers;

FIG. 7 illustrates one embodiment of the thermal management cover;

FIG. 8 illustrates another embodiment of the thermal management cover; and

FIGS. 9-12 illustrate varying embodiments of shapes of the thermal management cover.

A better understanding of the disclosed technology will be obtained from the following detailed description of the preferred embodiments taken in conjunction with the drawings and the attached claims.

### DETAILED DESCRIPTION

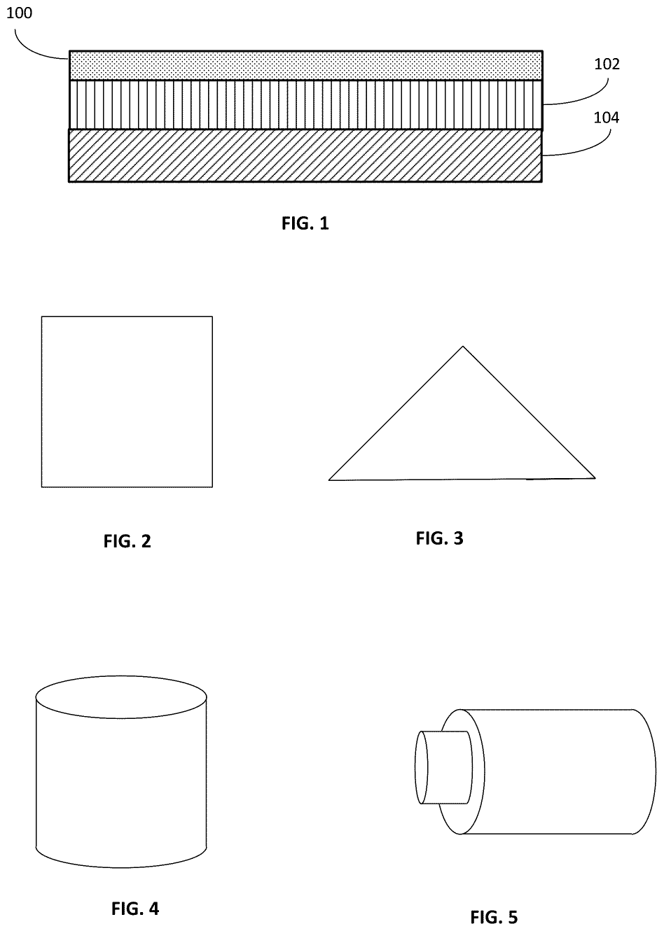

FIG. 1 illustrates a first embodiment of the thermal management composite material including three primary layers: a) a metalized material attached to a woven or non-woven material 100; b) an ultra-low thermally conductive material layer 102; and c) a metalized material attached to a woven or non-woven material 104.

In aspects, the metalized material 100 and/or 104 can be aluminum. In aspects, the metalized material 100 and/or 104 can have a radiation reflectivity of 80% or greater. The woven or non-woven material 100 and/or 104 can be by way of example only, para-aramid material such as a Kevlar®. The ultra-low thermally conductive material can be by way of example only a carbon felt.

In one embodiment, the composite material's innermost layer can comprise a metalized material. In one embodiment, the composite material's outermost layer can comprise a metalized material.

In one embodiment, an outer layer can be woven or non-woven material. For example, woven may include a canvas, nylon or polyester, ripstop among others. Non-woven can be polymer materials that are additively manufactured, injection molded, among other techniques, and/or other polymeric materials.

A sheet of the composite material can be laid flat, so that on each side of the material the outermost layer is metalized. The composite material can have all or a portion of each of the layers affixed and/or bonded to one another. For example, bonding of layers herein can include any known techniques including compression, adhesive, among others.

The composite material can be longer than it is wide. FIGS. 2-4 illustrates varying shapes of composite material, including a square or rectangular shape, a triangular shape, a vertical tubelike formation. FIG. 5 illustrates one embodiment of composite material being rolled around a tube or other element.

In aspects, the outer layer or other layers can comprise small openings or apertures/perforations having a functionality and the zones between the opening in cases have functionality. In aspects, the aperture size can range from 0.01 mm to 10 mm depending on the application. Apertures can be applied in a uniform pattern (symmetrically) or be varied across the outer layer to alter the thermal signature/pattern when viewing the material through infrared lenses, cameras, etc. Apertures can also allow for the reflectivity of the second layer to reflect radiant heat away from inner layers. Apertures can be round or any other shape, an may be varied in shape across the outer layer to alter the thermal signature/pattern when viewing the material through infrared lenses, cameras, etc. The outermost layer can be a woven or non-woven material. By way of example, the woven can be a canvas, nylon or polyester riptstop, non-woven. It can be a polymer material that is additively manufactured, injection molded, etc. or other polymeric materials. In applications and aspects of the material, such openings can be critical to functionality, such as in the sense that colors or patterns can be added versus just the reflectivity of the second layer. They can also be critical in changing the thermal signature of anything being covered by the material, and it can change the thermal properties of the layers, layers, or overall composite material.

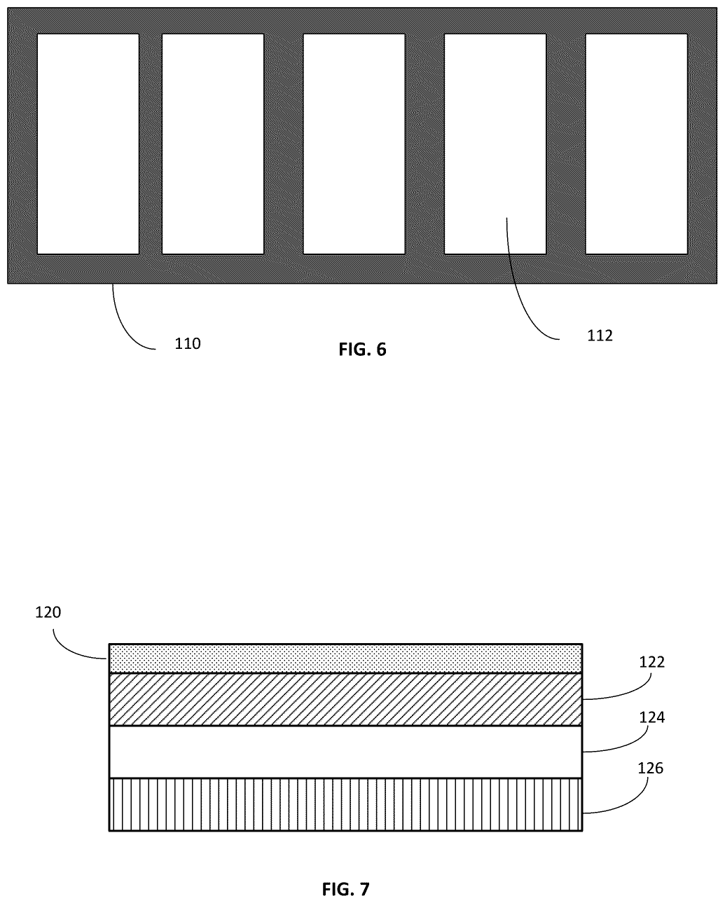

In one embodiment, the composite material can have a plurality of distance separated standoff spacer strips affixed to the outside layer of the composite material. The standoff spacer strips can comprise of a high temperature thermal resistant plastic or rubber. The standoff spacer strips can be flexible. The standoff spacer strips can be distance separated from one another and positioned widthwise across the composite material. By way of example, FIG. 6 illustrates a strip of material 112 with spacers 110 therein.

In one embodiment, the composite material can be capable of being rolled. The composite material can be capable of being rolled widthwise making a long vertical tubelike formation. For example, in one embodiment the composite material can comprise a fastener that upon being attached maintains the vertical tubelike formation.

In varying embodiments, the fastener can be one or more of: a mechanical fastener, a magnetic fastener, a loop and hook fastener, a wire fastener, a snap fastener, a zipper fastener, an interlocking mushroom head fastener, and/or a male-female fastener, or any other suitable fastener as recognized by a skilled artisan.

The fastener can, once fastened, form a thermally resistant seal that reduces thermal air exchange between the outside air temperature and the inside air temperature within the tube-like or sleeve-like formation.

Two or more layers of the composite material can be attached and/or bonded to one another by one or more of: glue, lamination, stitching, staples, heat bonding, heat, and pressure bonding. In aspects, the composite material is rigid or substantially rigid. In other aspects, the composite material can be flexible, non-rigid, malleable, and/or deformable.

FIG. 1 additionally illustrates a second embodiment a thermal management composite material, wherein the material comprises three primary layers, including: a) the metalized material attached to a woven or non-woven material 100; b) the ultra-low thermally conductive material layer 102; and c) the metalized material attached to a woven or non-woven material 104.

In aspects, the thermal protecting composite material is in the form of one of: a square, a rectangle, a triangle, or a cylinder, such as noted in FIGS. 2-4.

In aspects, the metalized material can be aluminum. In aspects, the metalized material can have a radiation reflectivity of 80% or greater. In aspects, the woven or non-woven material can be an aramid or para-aramid type fiber for example material available under the brand name Kevlar® or a similar material as recognized by a skilled artisan, such as Mylar®.

In aspects, the ultra-low thermally conductive material can be by way of example only a carbon felt.

In aspects, the composite material's innermost layer can be comprised of a metalized material. In aspects, the composite material's outermost layer can be comprised of a metalized material. In aspects, a sheet of the composite material can be laid flat, so that on each side of the material the outermost layer is metalized.

FIG. 1 also illustrates the third embodiment of the thermal management composite material, wherein the material is comprised of three primary layers: a) a metalized material attached to a woven or non-woven material; b) an ultra-low thermally conductive material layer; and c) a metalized material attached to a woven or non-woven material. In aspects, the thermal protecting composite material can be formed into the shape of a covering for a tube, covering for a hose, covering for a conduit, or covering for a duct, such as illustrated in FIG. 5.

In aspects, the metalized material can be aluminum. In aspects, the metalized material can have a radiation reflectivity of 80% or greater. In aspects, the woven or non-woven material can be by way of example only, Kevlar®.

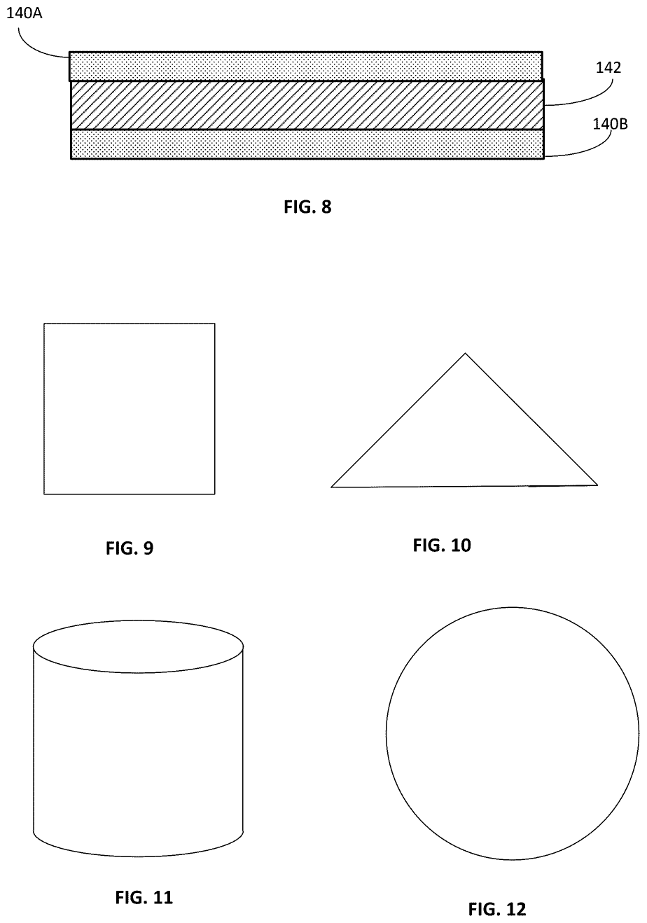

FIG. 8 illustrates a fourth embodiment of the invention, here providing for a thermal management cover. The cover is comprised of four layers: a) an outer woven or non-woven material layer 120, either of which comprises a plurality of perforations; b) a metalized material layer 122; c) an ultra-low thermally conductive material layer 124; and d) an inner woven or non-woven material 126.

The cover can comprise four layers that can be attached or bonded to one another. In aspects, the ultra-low thermally conductive material layer can comprise ceramic or other ultra-low conductive material. In aspects, the metalized material layer can comprise aluminum. In aspects, the metalized material can have a radiation reflectivity of 80% or greater. In aspects, perforations in the outermost layer can alter the thermal signature of the cover and provide further functionality as described herein.

The cover can be in any shape, by way of example only, one of: a square, a rectangle, a triangle, an oval, and a circle. In aspects, the metalized material can be aluminum. In aspects, the metalized material can have a radiation reflectivity of 80% or greater. The woven or non-woven material can be by way of example only Kevlar. The ultra-low thermally conductive material can be by way of example only carbon felt. The composite material's innermost layer can be comprised of a woven or non-woven material.

The composite material's outermost layer, innermost layer, or both, can comprise woven or non-woven material, which can include a plurality of perforations. In aspects, a sheet of the composite material can be laid flat such that on each side of the material the outermost layer is perforated. The composite material can have all or a portion of each of the layers affixed or bonded to one another. The composite material can be longer than it is wide. The composite material can have a plurality of distance separated standoff spacer strips affixed to the outside layer of the composite material.

The standoff spacer strips can be comprised of a high temperature thermal resistant plastic or rubber. The standoff spacer strips can be flexible. The standoff spacer strips can be distance separated from one another and positioned widthwise across the composite material. The composite material can be capable of being rolled. The composite material can be capable of being rolled widthwise making a long vertical tubelike formation.

The composite material can comprise a fastener that upon being attached maintains the material in a vertical tubelike formation. The fastener can be one or more of: a mechanical fastener, a magnetic fastener, a loop and hook fastener, a wire fastener, a snap fastener, a zipper fastener, an interlocking mushroom head fastener, and/or a male-female fastener. In aspects, the fastener upon being fastened can form a thermally resistant seal that reduces thermal air exchange between the outside air temperature and the inside air temperature within the tubelike formation.

Two or more layers can be attached or bonded to one another by one or more of: a glue, a lamination, stitching, staples, heat bonding, heat, and/or pressure bonding.

FIG. 8 illustrates a fifth embodiment of the invention, also a thermal management cover, wherein the cover is comprised of one or more panels, wherein a panel is comprised of three primary layers: a) a fiber reinforced plastic board comprised of one or more of: carbon, fiberglass, and/or polyethylene terephthalate glycol, known as PETG or PET-G 140A; b) one or more of polystyrene or another low conductive material 142; and c) fiber reinforced plastic board comprised of one or more of: carbon, fiberglass, and/or PETG 140B.

In aspects, the outermost side of the cover can be white.

In aspects, the cover can comprise two or more layers that can be attached or bonded to one another. The cover can be of any shape by way of example one of: a square, a rectangle, a triangle, an oval, or a circle, such as illustrated in FIGS. 9-12.

In aspects, the cover can be affixed, bonded, connected, and/or attached to a PCA or air conditioning unit by way of example only: magnets, straps, and/or mechanical or cloth fasteners. In aspects, the thermal management cover can be laid over or otherwise cover a PCA or air conditioning unit without being affixed, bonded, connected, and/or attached to the PCA or air conditioning unit. In aspects, the cover can be releasably affixed, bonded, connected, and/or attached to a PCA or air conditioning unit. In aspects, the thermal management cover can be rigid or substantially rigid. In other aspects, the thermal management cover can be flexible, non-rigid, malleable, and/or deformable. The materials described herein can be used in conjunction with any electronic device or any material that is preferably insulated against heat and/or cold.

The composite material and cover can provide for a significant improvement in the thermal management of air flow that flows into and out of an aircraft or other vehicle. In one embodiment a cover can include perforations or other apertures. These perforations allow for both airflow, as well as reflection of radiant heat off of a second layer.

The apertures can range in sizes, including in various embodiments having sizing between 0.01 mm to 10 mm, depending in part on the underlying temperature management application. Moreover, the apertures can be in a unified pattern or shape or further embodiments can include variations in patterns allowing for altering a thermal signature or pattern when viewed through an infrared lens or camera. Similarly, the apertures can vary in shape, ranging from circular to oval, further providing for adjustment of heat signature and reflection of radiant heat.

For example, in one embodiment, the composite material overcomes the prior art limitations associated with thermal management, including management of a PCA unit and insulated hose, as well as other electronics.

The invention herein includes several Aspects.
Aspect 1: A thermal management composite material comprising at least three primary layers:
1. a first metalized material attached to a first woven or non-woven material;
2. an ultra-low thermally conductive material layer; and
3. a second metalized material attached to a second woven or non-woven material; and
wherein the thermal management composite material is provided in a form of one of a square, a rectangle, a triangle, or a cylinder.
Aspect 2: The thermal management composite material of Aspect 1, wherein the first and/or the second metalized material is aluminum.
Aspect 3: The thermal management composite material of Aspect 1, wherein the first and/or the second metalized material has a radiation reflectivity of 80% or greater.
Aspect 4: The thermal management composite material of Aspect 1, wherein the woven or non-woven material is Kevlar.
Aspect 5: The thermal management composite material of Aspect 1, wherein the woven or non-woven material is carbon felt.
Aspect 6: The thermal management composite material of Aspect 1, wherein an innermost layer is comprised of the first or the second metalized material.
Aspect 7: The thermal management composite material of Aspect 1, wherein an outermost layer is comprised of the first or the second metalized material.
Aspect 8: The thermal management composite material of Aspect 1, wherein the outermost layer and the innermost layer have a metalized surface comprising the first and/or the second metalized material.
Aspect 9: The thermal management composite material of Aspect 1, wherein all or a portion of each of the layers are affixed or bonded to one another.
Aspect 10: The thermal management composite material of Aspect 1, wherein the thermal management composite material is provided having a length greater than its width.
Aspect 11: The thermal management composite material of Aspect 1, wherein the thermal management composite material has a plurality of distance separated standoff spacer strips affixed to an outside layer of the thermal management composite material.
Aspect 12: The thermal management composite material of Aspect 11, wherein the standoff spacer strips are comprised of a high temperature thermal resistant plastic or rubber.
Aspect 13: The thermal management composite material of Aspect 11, wherein the standoff spacer strips are flexible.
Aspect 14: The thermal management composite material of Aspect 11, wherein the standoff spacer strips are distance separated from one another and positioned widthwise across the thermal management composite material.
Aspect 15: The thermal management composite material of Aspect 1, wherein the thermal management composite material is capable of being rolled.
Aspect 16: The thermal management composite material of Aspect 1, wherein the composite material is capable of being rolled widthwise making a long vertical tubelike formation.
Aspect 17: The thermal management composite material of Aspect 16, wherein the thermal management compositive material comprises a fastener that upon being fastened maintains the vertical tubelike formation.
Aspect 18: The thermal management composite material of Aspect 17, wherein the fastener is one or more of: a mechanical fastener, a magnetic fastener, a loop and hook fastener, a wire fastener, a snap fastener, a zipper fastener, an interlocking mushroom head fastener, and/or a male-female fastener.
Aspect 19: The thermal management composite material of Aspect 17, wherein the fastener is capable of forming a thermally resistant seal that reduces thermal air exchange between an outside air temperature and an inside air temperature within the tubelike formation.
Aspect 20: The thermal management composite material of Aspect 1, wherein two or more layers can be attached or bonded to one another by one or more of: a glue, lamination, stitching, staples, heat bonding, heat, and/or pressure bonding,
Aspect 21: A thermal management composite material, wherein the material is comprised of at least three primary layers:
1. a first metalized material attached to a first woven or non-woven material;
2. an ultra-low thermally conductive material layer; and
3. a second metalized material attached to a second woven or non-woven material; and
   wherein the thermal management composite material is capable of being formed into a shape of a covering for a tube, a covering for a hose, a covering for a conduit, and/or a covering for a duct.
Aspect 22: The thermal management composite material of Aspect 21, wherein the first and/or the second metalized material is aluminum.
Aspect 23: The thermal management composite material of Aspect 21, wherein the first and/or the second metalized material provides a radiation reflectivity of 80% or greater.
Aspect 24: The thermal management composite material of Aspect 21, wherein the woven or non-woven material is Kevlar.
Aspect 25: The thermal management composite material of Aspect 21, wherein the woven or non-woven material is carbon felt.
Aspect 26: The thermal management composite material of Aspect 21, wherein an innermost layer is comprised of the second metalized material.
Aspect 27: The thermal management composite material of Aspect 21, wherein an outermost layer is comprised of the first metalized material.
Aspect 28: The thermal management composite material of Aspect 27, wherein the outermost layer and the innermost layer have a metalized surface.
Aspect 29: The thermal management composite material of Aspect 21, wherein all or a portion of each of the layers are affixed or bonded to one another.
Aspect 30: The thermal management composite material of Aspect 21, wherein the thermal management composite material is provided having a length greater than its width.
Aspect 31: The thermal management composite material of Aspect 21, wherein the thermal management composite material has a plurality of distance separated standoff spacer strips affixed to an outside layer of the thermal management composite material.
Aspect 32: The thermal management composite material of Aspect 31, wherein the standoff spacer strips are comprised of a high temperature thermal resistant plastic or rubber.
Aspect 33: The thermal management composite material of Aspect 31, wherein the standoff spacer strips are flexible.
Aspect 34: The thermal management composite material of Aspect 31, wherein the standoff spacer strips are distance separated from one another and positioned widthwise across the thermal management composite material.
Aspect 35: The thermal management composite material of Aspect 21, wherein the thermal management composite material is capable of being rolled.
Aspect 36: The thermal management composite material of Aspect 21, wherein the thermal management composite material is capable of being rolled widthwise making a long vertical tubelike formation.
Aspect 37: The thermal management composite material of Aspect 36, wherein the thermal management compositive material comprises a fastener that upon being fastened maintains the vertical tubelike formation.
Aspect 38: The thermal management composite material of Aspect 37, wherein the fastener is one or more of: a mechanical fastener, a magnetic fastener, a loop and hook fastener, a wire fastener, a snap fastener, a zipper fastener, an interlocking mushroom head fastener, and a male-female fastener.
Aspect 39: The thermal management composite material of Aspect 37, wherein the fastener is capable of forming a thermally resistant seal that reduces thermal air exchange between an outside air temperature and an inside air temperature within the tubelike formation.
Aspect 40: The thermal management composite material of Aspect 21, wherein two or more layers can be attached or bonded to one another by one or more of: a glue, lamination, stitching, staples, heat bonding, heat, and/or pressure bonding,
Aspect 41: A thermal management cover, wherein the cover is comprised of at least four layers:
1. an outer woven or non-woven material layer, wherein the outer woven or non-woven material layer includes a plurality of perforations;
2. a metalized material layer;
3. an ultra-low thermally conductive material layer; and
4. in inner woven or non-woven material.
Aspect 42: The thermal management cover of Aspect 41, wherein the four layers are attached or bonded to one another to create a composite material.
Aspect 43: The thermal management cover of Aspect 41, wherein the ultra-low thermally conductive material layer comprises ceramic or another ultra-low conductive material.
Aspect 44: The thermal management cover of Aspect 41, wherein the metalized material layer comprises aluminum.
Aspect 45: The thermal management cover of Aspect 41, wherein the metalized material provides a radiation reflectivity of 80% or greater.
Aspect 46: The thermal management cover of Aspect 41, wherein a shape and pattern of the plurality of perforation alters a thermal signature of the thermal management cover.
Aspect 47: The thermal management cover of Aspect 41, wherein the thermal management cover is provided in a shape of one of a square, a rectangle, a triangle, an oval, or a circle.
Aspect 48: The thermal management cover of Aspect 41, wherein the metalized material layer is aluminum.
Aspect 49: The thermal management cover of Aspect 41, wherein the metalized material layer provides a radiation reflectivity of 80% or greater.
Aspect 50: The thermal management cover of Aspect 41, wherein the woven or non-woven material is Kevlar.
Aspect 51: The thermal management cover of Aspect 41, wherein the woven or non-woven material is carbon felt.
Aspect 52: The thermal management cover of Aspect 41, wherein an outermost layer and an innermost layer include perforations.
Aspect 53: The thermal management cover of Aspect 41, wherein the thermal management cover is provided having a length greater than its width.
Aspect 54: The thermal management cover of Aspect 41, wherein the thermal management cover has a plurality of distance separated standoff spacer strips affixed to an outside layer of the thermal management cover.
Aspect 55: The thermal management cover of Aspect 54, wherein the standoff spacer strips are comprised of a high temperature thermal resistant plastic or rubber.
Aspect 56: The thermal management cover of Aspect 54, wherein the standoff spacer strips are flexible.
Aspect 57: The thermal management cover of Aspect 54, wherein the standoff spacer strips are distance separated from one another and positioned widthwise across the thermal management cover.
Aspect 58: The thermal management cover of Aspect 41, wherein the thermal management cover is capable of being rolled.
Aspect 59: The thermal management cover of Aspect 41, wherein the composite material is capable of being rolled widthwise making a long vertical tubelike formation.
Aspect 60: The thermal management cover of Aspect 59, wherein the thermal management cover comprises a fastener that upon being fastened maintains the vertical tubelike formation.
Aspect 61: The thermal management cover of Aspect 60, wherein the fastener is one or more of: a mechanical fastener, a magnetic fastener, a loop and hook fastener, a wire fastener, a snap fastener, a zipper fastener, an interlocking mushroom head fastener, and/or a male-female fastener.
Aspect 62: The thermal management cover of Aspect 60, wherein the fastener is capable of forming a thermally resistant seal that reduces thermal air exchange between an outside air temperature and an inside air temperature within the tubelike formation.
Aspect 63: The thermal management cover of Aspect 41, wherein two or more layers can be attached or bonded to one another by one or more of: a glue, lamination, stitching, staples, heat bonding, heat, and/or pressure bonding,
Aspect 64: A thermal management cover, wherein the cover is comprised of one or more panels, wherein at least one panel of the one or more panels comprises at least three layers:
1. a second fiber reinforced plastic board comprising one or more of carbon, fiberglass, or PETG;
2. polystyrene or another low conductive material; and
3. a first fiber reinforced plastic board comprising one or more of carbon, fiberglass, and/or PETG.
Aspect 65: The thermal management cover of Aspect 64, wherein an outermost side of the thermal management cover is white.
Aspect 66: The thermal management cover of Aspect 64, wherein two or more of the at least three layers are attached or bonded to one another.
Aspect 67: The thermal management cover of Aspect 64, wherein the thermal management cover is provided in the shape of one of a square, a rectangle, a triangle, an oval, or a circle.
Aspect 68: The thermal management cover of Aspect 64, wherein the thermal management cover is affixed to an air conditioning unit using one or more of: magnets, straps, and/or mechanical or cloth fasteners.

FIGS. 1 through 11 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

As used herein, the term “about” refers to plus or minus 5 units (e.g., percentage) of the stated value.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

As used herein, the term “substantial” and “substantially” refers to what is easily recognizable to one of ordinary skill in the art.

It is to be understood that the phraseology and terminology employed herein is not to be construed as limiting and are for descriptive purpose only.

It is to be understood that while certain of the illustrations and figure may be close to the right scale, most of the illustrations and figures are not intended to be of the correct scale.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

What is claimed is:

1. A thermal management composite material comprising:
a first metalized material attached to a first woven or non-woven material;
an ultra-low thermally conductive material layer; and
a second metalized material attached to a second woven or non-woven material;
wherein an outermost layer of the thermal management composite material comprises a plurality of apertures, and wherein one or more of the plurality of apertures exposes the first metalized material.

2. The thermal management composite material of claim 1, wherein the first and/or second metalized material is aluminum.

3. The thermal management composite material of claim 1, wherein the first and/or second metalized material provides a radiation reflectivity of 80% or greater.

4. The thermal management composite material of claim 1, wherein the woven or non-woven material is a para-aramid material.

5. The thermal management composite material of claim 1, wherein the woven or non-woven material is carbon felt.

6. The thermal management composite material of claim 1, wherein an innermost layer of the thermal management composite material comprises the metalized material attached to the woven or non-woven material.

7. The thermal management composite material of claim 1, wherein the outermost layer comprises the first metalized material attached to the woven or non-woven material.

8. The thermal management composite material of claim 1, wherein the innermost side and the outermost side have a metalized surface comprising the first or the second metalized material.

9. The thermal management composite material of claim 1, wherein all or a portion of each of the layers are affixed or bonded to one another.

10. The thermal management composite material of claim 1, wherein the thermal management composite material is provided such that its length is greater than its width.

11. The thermal management composite material of claim 1, wherein the thermal management composite material includes a plurality of distance separated standoff spacer strips affixed to an outside layer of the thermal management composite material.

12. The thermal management composite material of claim 11, wherein the standoff spacer strips comprise a high temperature thermal resistant plastic or rubber.

13. The thermal management composite material of claim 11, wherein the standoff spacer strips are flexible.

14. The thermal management composite material of claim 11, wherein the standoff spacer strips are distance separated from one another and positioned widthwise across the thermal management composite material.

15. The thermal management composite material of claim 1, wherein the thermal management composite material is capable of being rolled.

16. The thermal management composite material of claim 1, wherein the thermal management composite material is capable of being rolled widthwise making a long vertical tubelike formation.

17. The thermal management composite material of claim 16, wherein the thermal management composite material comprises a fastener that upon being fastened maintains the vertical tubelike formation.

18. The thermal management composite material of claim 17, wherein the fastener is one or more of: a mechanical fastener, a magnetic fastener, a loop and hook fastener, a wire fastener, a snap fastener, a zipper fastener, an interlocking mushroom head fastener, and/or a male-female fastener.

19. The thermal management composite material of claim 17, wherein the fastener is capable of forming a thermally resistant seal that reduces thermal air exchange between an outside air temperature and an inside air temperature within the tubelike formation.

20. The thermal management composite material of claim 1, wherein two or more layers can be attached or bonded to one another by one or more of: a glue, lamination, stitching, staples, heat bonding, heat, and/or pressure bonding,

21. The thermal management composite material of claim 1, wherein the thermal management composite material is provided in a form of one of: a square, a rectangle, a triangle, or a cylinder.

22. The thermal management composite material of claim 1, wherein the thermal management composite material is capable of being formed into a shape of a covering for a tube, a covering for a hose, a covering for a conduit, and/or a covering for a duct.

23. The thermal management composite material of claim 1, wherein diameter or a radius of one or more of the plurality of apertures range in size from 0.01 mm to 10 mm.

24. The thermal management composite material of claim 1, wherein the plurality of apertures are applied in a uniform pattern across the outermost layer.

25. The thermal management composite material of claim 1, wherein the plurality of apertures are applied in a varied formation across the outermost layer

26. The thermal management composite material of claim 1, wherein the plurality of apertures function to alter a thermal signature of the thermal management composite material when the thermal management composite material is viewed through an infrared lenses or camera.

27. The thermal management composite material of claim 1, wherein the plurality of apertures allow for a one or more inner layers of the thermal management composite material to reflect radiant heat away from the one or more inner layers, a cavity formed by the thermal management composite material, or both.

28. The thermal management composite material of claim 1, wherein a number of apertures of the plurality of apertures per square inch of the outermost layer of the thermal management composite material ranges between about 5 apertures per square inch of the outermost layer of the thermal management composite material to about 100 apertures per square inch of the outermost layer of the thermal management composite material.
